(19) United States
(12) Patent Application Publication
(10) Pub. No.: US 2009/0180700 A1
(43) Pub. Date: Jul. 16, 2009

(54) De-blocking filter and method for de-blocking filtering of video data

(75) Inventors: Han-Sang Kim, Suwon-si (KR); Denis Gorodetskii, Suwon-si (KR); Yun-Je Oh, Yongin-si (KR); Kwang-Pyo Choi, Anyang-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 12/321,031

(22) Filed: Jan. 15, 2009

(30) Foreign Application Priority Data
Jan. 15, 2008 (KR) 10-2008-0004354

(51) Int. Cl. G06K 9/36

(52) U.S. Cl. 382/233

(57) ABSTRACT

Disclosed is a method and apparatus for de-blocking filtering of video data. The method includes performing Integer Transform (IT) of an input data block, scaling the data block, which has been IT-ed and indicates a frequency domain, by applying a modified scaling matrix in which a high frequency area is set to 0, performing Inverse Integer Transform (IIT) on the scaled block.

### CLAIM OF PRIORITY

This application claims the benefit of the earlier filing date, pursuant to 35 U.S.C. §119(a), to that patent application entitled “De-Blocking Filter And Method For De-Blocking Filtering Of Video Data” filed in the Korean Intellectual Property Office on Jan. 15, 2008 and assigned Serial No. 10-2008-0004354, the contents of which are hereby incorporated by reference.

### BACKGROUND OF THE INVENTION

1. Field of the Invention

The present invention relates to a video codec, and more particularly to a de-blocking filtering method for removing blocking artifacts at the time of decoding of raw video data.

2. Description of the Related Art

Most current video processing systems use video data compressed by standardized video codec. The video codecs generally used include codec standards, such as H.261, H.262, and H.263, which are recommended by the International Telecommunication Union (ITU), and MPEG-1, MPEG-2, and MPEG-4, which are recommended by the Motion Picture Experts Group (MPEG). Further, active research and standardization for the H.264 video codec, which can achieve a higher compression rate, is in progress.

The encoded video data is decoded into original data through a separate decoding process in an image processing apparatus, so that the original data is displayed on a screen.

In general, a video decoder system includes a parser, a plurality of hardware modules for decoding encoded video data, memories, and peripheral devices such as a Direct Memory Access (DMA). Further, each of these elements transmits data to another element through a bus. The hardware modules for decoding include an entropy decoder, an inverse transformer, a predictor, and a de-blocking filter.

The encoded video data is sequentially processed by the hardware modules so that the encoded video data is restored to original data. Further, during the decoding, corresponding hardware modules are connected to an external memory, or an internal memory, implemented as an SRAM, wherein necessary data is read from the memory or processed data is stored in the memory.

Meanwhile, the video data are compressed macro block by macro block. Therefore, when such video data have been restored, a block effect occurs wherein a difference is found in every boundary area between blocks of the restored video due to video data value or discontinuity of inclination. The blocking effect can be easily detected since it has a shape of a rectangular grating along a boundary of each block. Therefore, the blocking effect serves as a factor of degrading the subjective screen quality.

Therefore, in order to reduce such a blocking effect, a de-blocking process is performed. The de-blocking process is a process for reducing the blocking effect, and a hardware module for performing the de-blocking process is referred to as a de-blocking filter.

The de-blocking filter first selects edges for a filtering operation, reads pixel data of the selected edges from a memory (external or internal), and stores the pixel data in a register array within the de-blocking filter. Further, the de-blocking filter determines a filtering strength of a boundary filter such that it can prevent excessive filtering while keeping edge parts of an actual picture alive. Next, through comparison with a threshold value, the de-blocking filter makes a final decision about whether to perform the filtering. If the decision to perform the filtering is made, the de-blocking filter performs the filtering by using pixel data of the corresponding edge stored in the register array, and outputs the filtered pixel.

An algorithm of the de-blocking process as described above is disclosed in detail in the H.264/AVC standard documents.

As described above, conventional multimedia video codec generates a blocking edge by performing block-by-block Discrete Cosine Transform (DCT) or motion compensation. In order to overcome this situation, such an edge can be smoothed by applying the de-blocking filter to the entire image. However, there are many limitations in using the de-blocking filter.

FIG. 1 briefly illustrates a de-blocking filtering method applied in the conventional H.263 annex J. As shown in FIG. 1, the de-blocking filter applied in the conventional H.263 annex J performs a vertical filtering by using a result of a horizontal filtering. Therefore, in the case of data of the 4×4 area located at an edge of a block having a 8×8 unit size, it is necessary to wait for a result of a preceding operation (horizontal filtering) before performing the following operation (vertical filtering).

FIG. 2 illustrates examples of pixel values of macro blocks according to the filtering operation in a de-blocking filtering method applied in the conventional H.263 annex J (see, Deblocking filter mode of 1998 H.263v2(H.263+).

Referring to FIG. 2, the blocks 210, 230, 260, and 290 at the left side correspond to 4×4 blocks having spatial domain values, and the blocks 220, 240, 250, 270, and 280 correspond to 4×4 blocks having frequency domain values.

When a de-blocking process is performed in the spatial domain, horizontal filtering and vertical filtering are performed by using horizontal and vertical offset values in the initial block 210 having initial values. Through the horizontal filtering and vertical filtering, a filtered 4×4 block 290 is obtained.

In the case of applying the above-described process to the frequency domain, the block 250 is obtained through horizontal filtering of the initial block 220, and the block 280 is obtained through vertical filtering of the block 250 (the drawing is comparison with the present invention although actual filtering operation is not performed in the frequency domain). Therefore, as noted from FIG. 2, the conventional de-blocking filtering method uses a result of the preceding operation in the following operation.

According to the conventional de-blocking method, since the result of the preceding operation is used in the following operation as described above, the quantity of operations required for de-blocking of, for example, h.264 or h.263 annex J occupies 20 to 40% of the entire operation. This increases the operation load. Moreover, since the conventional method uses not only horizontal pixel values but also vertical pixel values of two to six blocks, it is necessary to perform discontinuous memory access, which requires considerably long memory loading time. Furthermore, in the conventional method, the horizontal filtering order and vertical filtering order are predetermined according to the codec, and a result of a preceding operation has an effect on the result of the following filtering. Therefore, it is impossible to perform a parallel processing such as multi-threading, which is the main cause of codec efficiency degradation.

### SUMMARY OF THE INVENTION

The present invention provides a de-blocking filtering method and a de-blocking filter, which can reduce the quantity of required operations during a de-blocking filtering for removing blocking artifacts, so as to reduce the operation load and memory loading time, thereby improving the efficiency of the codec.

Also, the present invention provides a method of de-blocking filtering of video data, the method including the steps of performing Integer Transform (IT) of an input data block, scaling the data block, which has been IT-ed and indicates a frequency domain, by applying a modified scaling matrix in which a high frequency area is set to 0; performing Inverse Integer Transform (IIT) on the scaled block.

When the input data block is a 4×4 block, the IT is performed by

$$\begin{matrix}{X}^{′} = ( {C}_{f} {XC}_{f}^{T} ) \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ \begin{matrix}{x}_{00} & {x}_{01} & {x}_{02} & {x}_{03} \\ {x}_{10} & {x}_{11} & {x}_{12} & {x}_{13} \\ {x}_{20} & {x}_{21} & {x}_{22} & {x}_{23} \\ {x}_{30} & {x}_{31} & {x}_{32} & {x}_{33}\end{matrix} ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ) ,\end{matrix}$$

wherein X′ denotes an IT-ed block in a form of a matrix, C denotes a coefficient matrix, C^{T} denotes a transpose matrix of C, X denotes an input data block in a form of a matrix.

Application of the modified scaling matrix to the IT-ed block is performed by

Filtered Y=X′ [symbol] S′,

wherein Filtered Y corresponds to a value expressed in a form of a matrix, which is obtained by scaling the IT-ed block, X′ corresponds to the IT-ed block expressed in a form of a matrix, and S′ denotes a modified scaling matrix.

When the input data block is a 4×4 block, the modified scaling matrix is obtained by

$${S}^{′} = S ⊗ [ \begin{matrix}1 & 1 & 1 & 0 \\ 1 & 1 & 1 & 0 \\ 1 & 1 & 1 & 0 \\ 0 & 0 & 0 & 0\end{matrix} ] , and$$

$$\begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}$$

wherein S denotes a typical scaling matrix defined by equation (3),
S′ denotes a modified scaling matrix having a radio frequency area set to 0,

a=½, and b=\sqrt{2/5}.

When the input data block is a 4×4 block, the IIT is performed by

$$\begin{matrix}Filtered X = {C}_{i}^{T} ( Filtered Y ) {C}_{i} \\ = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] [ \begin{matrix}{y}_{00} & {y}_{01} & {y}_{02} & {y}_{03} \\ {y}_{10} & {y}_{11} & {y}_{12} & {y}_{13} \\ {y}_{20} & {y}_{21} & {y}_{22} & {y}_{23} \\ {y}_{30} & {y}_{31} & {y}_{32} & {y}_{33}\end{matrix} ] \\ [ \begin{matrix}1 & 1 & 1 & 1 \\ 1 & 1 / 2 & - 1 / 2 & - 1 \\ 1 & - 1 & - 1 & 1 \\ 1 / 2 & - 1 & 1 & 1 / 2\end{matrix} ] ,\end{matrix}$$

wherein Filtered X corresponds to a filtered final data block expressed in a form of a matrix, C denotes a coefficient matrix, C^{T} denotes a transpose matrix of C, and Filtered Y corresponds to a value expressed in a form of a matrix, which is obtained by scaling the IT-ed input data block.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a de-blocking filtering method applied in the conventional H.263 annex J;

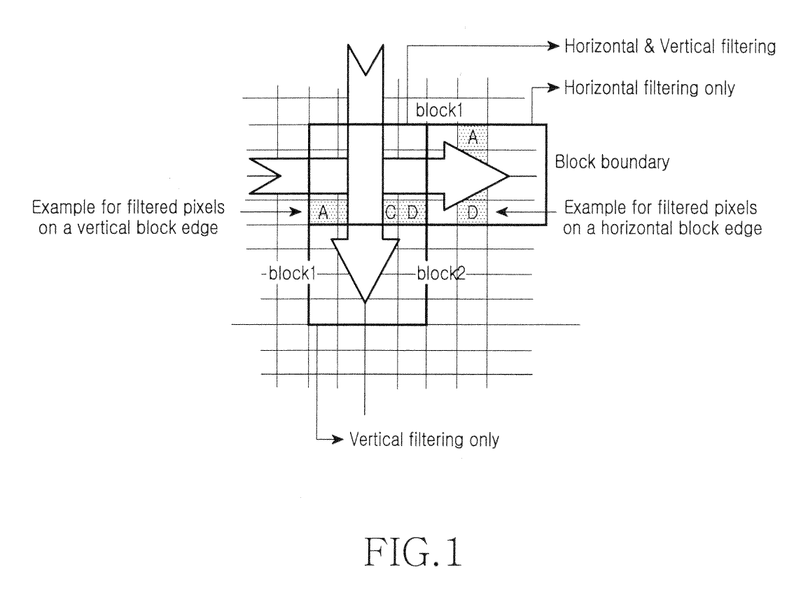

FIG. 2 illustrates examples of pixel values of macro blocks according to the filtering operation in a de-blocking filtering method applied in a conventional H.263 annex J;

FIG. 3 is a block diagram of a video decoding apparatus according to an embodiment of the present invention;

FIGS. 4A and 4B are flow diagrams for comparison of operation flow between a typical IT method and a de-blocking filtering method according to an embodiment of the present invention;

FIG. 5 illustrates examples of pixel values of macro blocks in a de-blocking filtering method according to an embodiment of the present invention; and

FIG. 6 illustrates examples of pictures for comparison of screen qualities between pictures using a de-blocking filtering method according to an embodiment of the present invention and pictures by the conventional method.

### DETAILED DESCRIPTION OF THE INVENTION

Exemplary embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

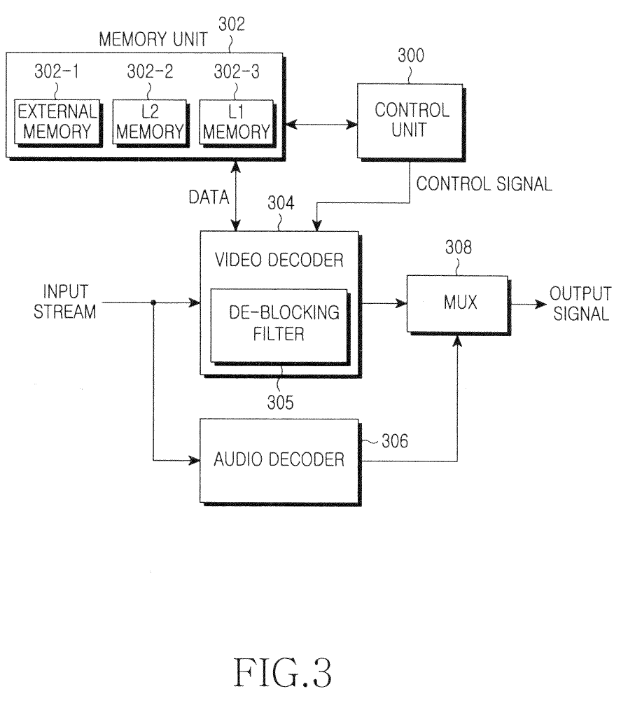

FIG. 3 is a block diagram of a video decoding apparatus according to an embodiment of the present invention. Hereinafter, an internal construction of a video decoder apparatus according to an embodiment of the present invention will be described with reference to FIG. 3. A video decoder apparatus according to the present invention includes a video decoder 304 having a de-blocking filter 305, an audio decoder 306, a memory unit 302, a multiplexer 308, and a control unit 300.

First, the video decoder 304 receives a video signal from among an input stream, decodes the video signal, and outputs the decoded video signal to the multiplexer 308. At this time, the de-blocking filter 305 filters the video signal in order to reduce the blocking artifacts generated in each macro block under the control of the control unit 300.

In performing the de-blocking filtering under the control of the control unit 300, the de-blocking filter 305 performs an Integer Transform (IT) on the input data block, performs scaling by using a modified scaling matrix according to the present invention, and then performs an Inverse Integer Transform (IIT).

The audio decoder 306 receives an audio signal, and decodes the audio signal for audio output.

The following description on the present invention discusses only the construction for achieving a rapid de-blocking when the control unit 300 controls the de-blocking filter 305, and a detailed description on the decoding operation for video output and the decoding operation for audio output will be omitted.

The multiplexer 308 multiplexes the decoded video and audio signals output from the video decoder 304 and the audio decoder 306, and outputs a multiplexed signal.

The memory unit 302 includes an external memory 302-1, and internal memories including an L2 memory 302-2 and an L3 memory 302-3. Especially, information such as a modified scaling matrix used for scaling or information used in the IT or IIT of a data block according to an embodiment of the present invention is stored in one of the memories described above.

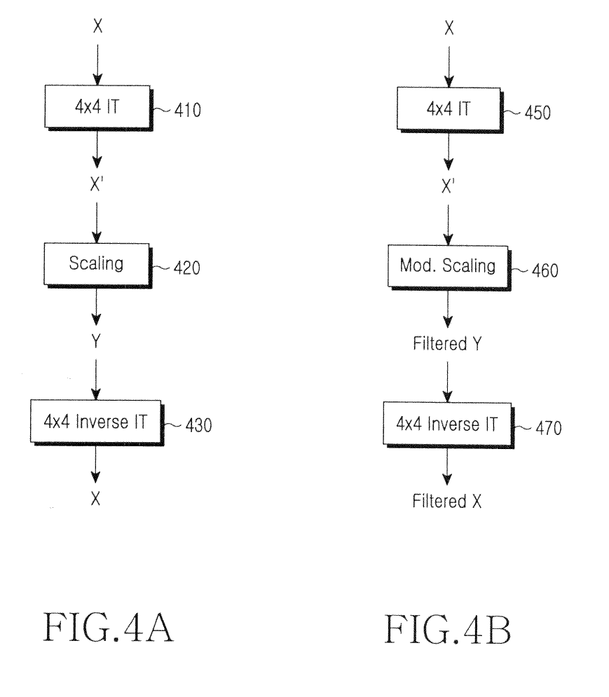

FIGS. 4A and 4B are flow diagrams for comparison of operation flow between a typical IT method and a de-blocking filtering method according to an embodiment of the present invention. FIG. 4A is a flow diagram of a typical IT method, and FIG. 4B is a flow diagram of a de-blocking filtering method according to an embodiment of the present invention.

Referring to FIG. 4A, showing a typical IT operation, an IT is first performed on an input 4×4 block X, so that the block X is converted to a block X′ (step 410). Then, in step 420, the block X′ is scaled, so that a value Y is obtained. Then, in step 403, an IIT is performed on the value Y, so that the value Y is converted to the original block X.

First, as used herein according to the present invention, a 4×4 IT is defined by equation (1) below and a 4×4 IIT is defined by equation (2) below.

$$\begin{matrix}\begin{matrix}Y = ( {C}_{r} {XC}_{r}^{T} ) ⊗ {E}_{r} \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ \begin{matrix}{x}_{00} & {x}_{01} & {x}_{02} & {x}_{03} \\ {x}_{10} & {x}_{11} & {x}_{12} & {x}_{13} \\ {x}_{20} & {x}_{21} & {x}_{22} & {x}_{23} \\ {x}_{30} & {x}_{31} & {x}_{32} & {x}_{33}\end{matrix} ] \\ [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ) ⊗ [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ]\end{matrix} & ( 1 ) \\ \begin{matrix}X = {C}_{i}^{T} ( Y ⊗ {E}_{i} ) {C}_{i} \\ = ( [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] [ \begin{matrix}{y}_{00} & {y}_{01} & {y}_{02} & {y}_{03} \\ {y}_{10} & {y}_{11} & {y}_{12} & {y}_{13} \\ {y}_{20} & {y}_{21} & {y}_{22} & {y}_{23} \\ {y}_{30} & {y}_{31} & {y}_{32} & {y}_{33}\end{matrix} ] ⊗ \\ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] ) ⊗ [ \begin{matrix}1 & 1 & 1 & 1 \\ 1 & 1 / 2 & - 1 / 2 & - 1 \\ 1 & - 1 & - 1 & 1 \\ 1 / 2 & - 1 & 1 & - 1 / 2\end{matrix} ]\end{matrix} & ( 2 )\end{matrix}$$

In equations (1) and (2), Y denotes a result of the IT, C denotes a coefficient matrix, C^{T} denotes a transpose matrix of C, X denotes a 4×4 data matrix, E denotes a constant matrix, a=½, and b=\sqrt{2/5}.

In step 410, output data X′ of the 4×4 IT is expressed as X′=C_{f}XC_{f}^{T}.

In the scaling in step 420, a scaling matrix S is used and has a value defined by equation (3) below.

$$\begin{matrix}\begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ]\end{matrix} & ( 3 )\end{matrix}$$

The scaling matrix S is applied to the X′ for the scaling in step 420, and the 4×4 IIT is performed in step 430, so that the output data matrix X is obtained. The output data matrix X obtained through steps 420 and 430 can be defined by X=Cᵢ^{T}(X′ [symbol] S)Cᵢ.

In brief, the 4×4 pixel data (matrix X) is converted to a frequency domain data (matrix X′) in step 410, the converted data is scaled in step 420, and the data is then converted to the initial 4×4 pixel data (matrix X) through the 4×4 IIT.

Next, a de-blocking filtering method according to an embodiment of the present invention will be described with reference to FIG. 4B. First, in step 450, an input 4×4 data block X is subjected to a 4×4 IT so that it is converted to X′. The IT in step 450 is defined by equation (4) below.

$$\begin{matrix}\begin{matrix}{X}^{′} = ( {C}_{f} {XC}_{f}^{T} ) \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ \begin{matrix}{x}_{00} & {x}_{01} & {x}_{02} & {x}_{03} \\ {x}_{10} & {x}_{11} & {x}_{12} & {x}_{13} \\ {x}_{20} & {x}_{21} & {x}_{22} & {x}_{23} \\ {x}_{30} & {x}_{31} & {x}_{32} & {x}_{33}\end{matrix} ] \\ [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] )\end{matrix} & ( 4 )\end{matrix}$$

In equation (4), X′ denotes an IT-ed block in the form of a matrix, C denotes a coefficient matrix, C^{T} denotes a transpose matrix of C, X denotes an input data block in the form of a matrix.

Next, in step 460, X′ is scaled by using a modified scaling matrix S′ according to the present invention, so that a filtered Y is obtained. The scaling in step 460 is defined by equation (5) below.

Filtered Y=X′ [symbol] S′ (5)

In equation (5), Filtered Y corresponds to a value expressed in the form of a matrix, which is obtained by scaling the IT-ed block, X′ corresponds to the IT-ed block expressed in the form of a matrix, and S′ denotes a modified scaling matrix.

The modified scaling matrix S′ used in step 460 is expressed by a frequency component. The modified scaling matrix S′ corresponds to a DC component at the left uppermost part, and indicates a coefficient value having a higher frequency component as it goes rightward or downward. Therefore, according to the present invention, in the scaling stage, the rightmost and lowermost component having the highest frequency component is changed to have a value of 0 and is then output. Therefore, the modified scaling matrix S′ is calculated by equation (6) defined below.

$${S}^{′} = S ⊗ [ \begin{matrix}1 & 1 & 1 & 0 \\ 1 & 1 & 1 & 0 \\ 1 & 1 & 1 & 0 \\ 0 & 0 & 0 & 0\end{matrix} ] \qquad ( 6 )$$

In equation (6), S denotes a typical scaling matrix defined by equation (3), and S′ denotes a modified scaling matrix having a radio frequency area set to 0.

According to the present embodiment, the modified scaling matrix is obtained through the method defined by equation (6). However, a method defined by equation (7) below may be used in order to obtain a modified scaling matrix.

$$S ⊗ [ \begin{matrix}1 & 1 & 1 & 1 \\ 1 & 1 & 1 & 0 \\ 1 & 1 & 1 & 0 \\ 0 & 0 & 0 & 0\end{matrix} ] , S ⊗ [ \begin{matrix}1 & 1 & 1 & 0 \\ 1 & 1 & 1 & 0 \\ 1 & 1 & 1 & 0 \\ 1 & 0 & 0 & 0\end{matrix} ] , S ⊗ [ \begin{matrix}1 & 1 & 1 & 0 \\ 1 & 1 & 1 & 0 \\ 1 & 1 & 1 & 1 \\ 0 & 0 & 1 & 1\end{matrix} ] \qquad ( 7 )$$

Next, in step 470, the filtered Y is subjected to a 4×4 IIT, so that it is converted to a de-blocking filtered X. The IIT in step 470 is defined by equation (8) below.

$$\begin{matrix}Filtered X = {C}_{i}^{T} ( Filtered Y ) {C}_{i} \\ = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] \\ [ \begin{matrix}{y}_{00} & {y}_{01} & {y}_{02} & {y}_{03} \\ {y}_{10} & {y}_{11} & {y}_{12} & {y}_{13} \\ {y}_{20} & {y}_{21} & {y}_{22} & {y}_{23} \\ {y}_{30} & {y}_{31} & {y}_{32} & {y}_{33}\end{matrix} ] [ \begin{matrix}1 & 1 & 1 & 1 \\ 1 & 1 / 2 & - 1 / 2 & - 1 \\ 1 & - 1 & - 1 & 1 \\ 1 / 2 & - 1 & 1 & - 1 / 2\end{matrix} ]\end{matrix} \qquad ( 8 )$$

In equation (8), Filtered X corresponds to a filtered final data block expressed in the form of a matrix, C denotes a coefficient matrix, C^{T} denotes a transpose matrix of C, and Filtered Y corresponds to a value expressed in the form of a matrix, which is obtained by scaling the IT-ed input data block.

The present invention can achieve a filtering effect, which can remove blocking artifacts through a transform of a scaling factor while using relational expressions of 4×4 IT and IIT. That is, although the operation of FIG. 4A yields the original value as a result of an IIT by a scaling matrix, the present invention can achieve a filtered pixel value through IIT using a modified scaling matrix S′ having a filtering effect.

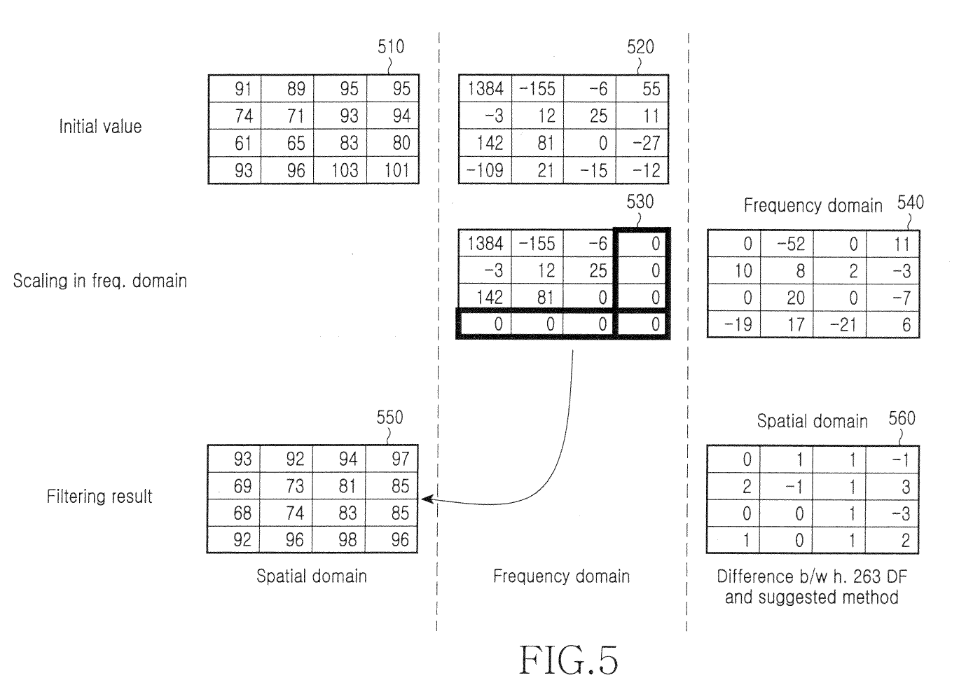

FIG. 5 illustrates examples of pixel values of macro blocks in a de-blocking filtering method according to an embodiment of the present invention.

Referring to FIG. 5, the blocks 510, 550, and 560 correspond to blocks having spatial domain values, and the blocks 520, 530, and 540 correspond to blocks having frequency domain values.

First, the block 510 is an initial block having 4×4 pixel values of the spatial domain. The initial block 510 is converted to the block 520 of the frequency domain at the right side through IT, and is then converted through scaling to the block 530, rightmost coefficient values and lowermost coefficient values of which are 0. Next, the block 530 is converted through IIT to the block 550 having low-pass filtered spatial domain values.

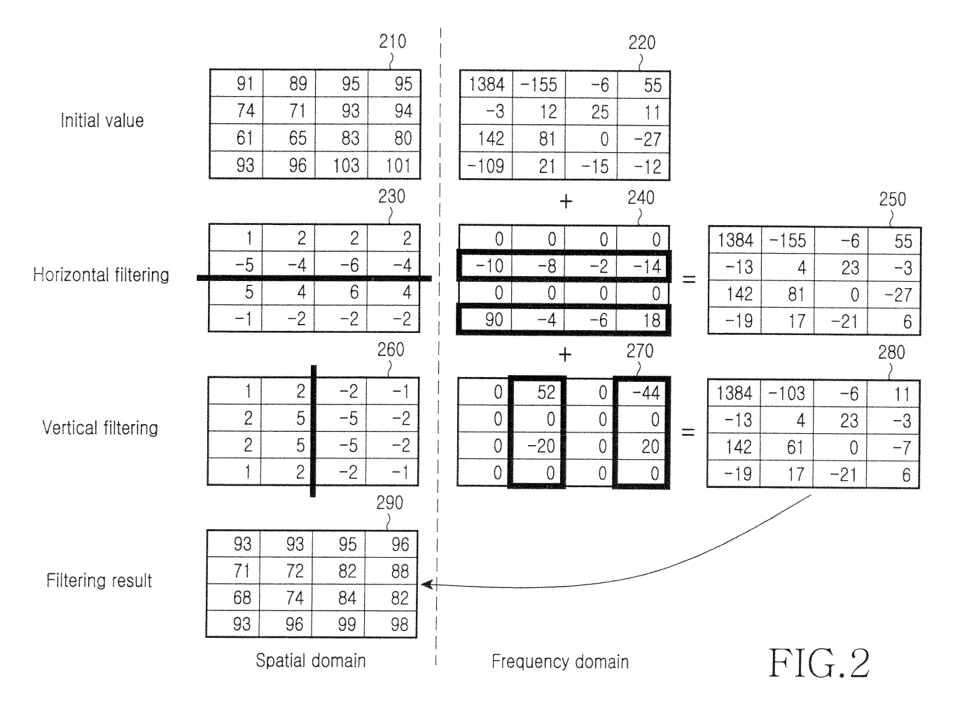

The block 560 (spatial domain) and the block 540 (frequency domain) have values showing differences between values of the blocks 550 and 530 obtained through de-blocking filtering according to an embodiment of the present invention and values of the blocks 290 and 280 of FIG. 2 obtained through the conventional h.263 de-blocking filtering. As noted from the blocks 560 and 540, the de-blocking filtering method according to an embodiment of the present invention shows a minute performance difference from the conventional method.

According to a result of an actual test for the entire frame, there was a minute difference, not exceeding about 0.1 dB, between the value output through the h.263 de-blocking filter and the value output through the filtering according to an embodiment of the present invention.

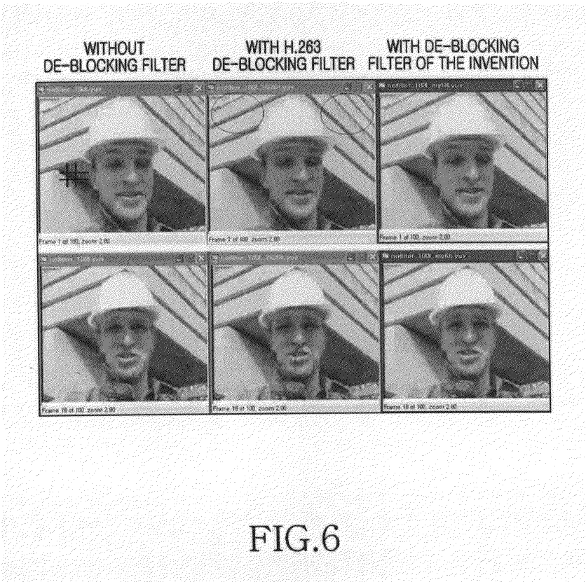

FIG. 6 illustrates examples of pictures for comparison of screen qualities between pictures using a de-blocking filtering method according to an embodiment of the present invention and pictures by the conventional method.

FIG. 6 compares subjective screen qualities of a de-blocking filter in the “foreman sequence,” wherein the left column includes images to which a de-blocking filter has not been applied, the middle column includes images to which the conventional h.263 de-blocking filter has been applied, the right column includes images to which a de-blocking filter according to an embodiment of the present invention has been applied.

In FIG. 6, screens of the first row correspond to screens of the first frame (intra) from among 100 frames, and screens of the second row correspond to screens of the 18^{th} frame (inter) from among 100 frames. All of the screens in FIG. 6 has been enlarged two times.

In the case of the left upper image, to which a de-blocking filter has not been applied, a clear block edge is observed as indicated by #. In the case of the images having used the h.263 de-blocking filter, it is possible to observe an unsmooth processing at the boundary part between blocks as noted from the encircled parts in the images of the middle column.

However, in the case of the images obtained through the method proposed by an embodiment of the present invention, it is possible to obtain a smooth image without a blocking edge differently from the two methods described above.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

The present invention can reduce the number of required operations during a de-blocking filtering for removing blocking artifacts, so as to reduce the operation load and memory loading time, thereby improving the efficiency of the codec. Further, the present invention enables reuse of an integer transform used in the H.264 codec.

The above description discusses a method and an apparatus for de-blocking filtering of video data according to an embodiment of the present invention. While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of de-blocking filtering of video data, the method comprising the steps of:
performing Integer Transform (IT) of an input data block;
scaling the data block, which has been IT-ed and indicates a frequency domain, by applying a modified scaling matrix in which a high frequency area is set to 0; and
performing Inverse Integer Transform (IIT) on the scaled block.

2. The method of claim 1, wherein, when the input data block is a 4×4 block, the IT is performed by
$$\begin{matrix}{X}^{′} = ( {C}_{f} X {C}_{f}^{T} ) \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ \begin{matrix}{x}_{00} & {x}_{01} & {x}_{02} & {x}_{03} \\ {x}_{10} & {x}_{11} & {x}_{12} & {x}_{13} \\ {x}_{20} & {x}_{21} & {x}_{22} & {x}_{23} \\ {x}_{30} & {x}_{31} & {x}_{32} & {x}_{33}\end{matrix} ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ) ,\end{matrix}$$
wherein X′ denotes an IT-ed block in a form of a matrix,
C denotes a coefficient matrix,
C^{T} denotes a transpose matrix of C,
X denotes an input data block in a form of a matrix.

3. The method of claim 1, wherein application of the modified scaling matrix to the IT-ed block is performed by
Filtered Y=X′ [symbol] ′,
wherein Filtered Y corresponds to a value expressed in a form of a matrix, which is obtained by scaling the IT-ed block,
X′ corresponds to the IT-ed block expressed in a form of a matrix, and
S′ denotes a modified scaling matrix.

4. The method of claim 1, wherein, when the input data block is a 4×4 block, the modified scaling matrix is obtained by
$$\begin{matrix}{S}^{′} = S ⊗ [ \begin{matrix}1 & 1 & 1 & 0 \\ 1 & 1 & 1 & 0 \\ 1 & 1 & 1 & 0 \\ 0 & 0 & 0 & 0\end{matrix} ] , and & \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix} & \end{matrix}$$
wherein S denotes a typical scaling matrix defined by equation (3),
S′ denotes a modified scaling matrix having a radio frequency area set to 0,
a=½, and b=\sqrt{2/5}.

5. The method of claim 1, wherein, when the input data block is a 4×4 block, the modified scaling matrix is obtained by
$$\begin{matrix}S ⊗ [ \begin{matrix}1 & 1 & 1 & 1 \\ 1 & 1 & 1 & 0 \\ 1 & 1 & 1 & 0 \\ 0 & 0 & 0 & 0\end{matrix} ] , and \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}\end{matrix}$$
wherein S denotes a scaling matrix defined by equation (3),
S′ denotes a modified scaling matrix having a radio frequency area set to 0,
a=½, and b=\sqrt{2/5}.

6. The method of claim 1, wherein, when the input data block is a 4×4 block, the modified scaling matrix is obtained by
$$\begin{matrix}S ⊗ [ \begin{matrix}1 & 1 & 1 & 0 \\ 1 & 1 & 1 & 0 \\ 1 & 1 & 1 & 0 \\ 1 & 0 & 0 & 0\end{matrix} ] , and \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}\end{matrix}$$
wherein S denotes a scaling matrix,
S′ denotes a modified scaling matrix having a radio frequency area set to 0,
a=½, and b=\sqrt{2/5}.

7. The method of claim 1, wherein, when the input data block is a 4×4 block, the modified scaling matrix is obtained by
$$\begin{matrix}S ⊗ [ \begin{matrix}1 & 1 & 1 & 0 \\ 1 & 1 & 1 & 0 \\ 1 & 1 & 1 & 1 \\ 0 & 0 & 1 & 1\end{matrix} ] , and \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}\end{matrix}$$
wherein S denotes a typical scaling matrix,
S′ denotes a modified scaling matrix having a radio frequency area set to 0,
a=½, and b=\sqrt{2/5}.

8. The method of claim 1, wherein, when the input data block is a 4×4 block, the IIT is performed by
$$\begin{matrix}Filtered X = {C}_{i}^{T} ( Filtered Y ) {C}_{i} \\ = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] \\ [ \begin{matrix}{y}_{00} & {y}_{01} & {y}_{02} & {y}_{03} \\ {y}_{10} & {y}_{11} & {y}_{12} & {y}_{13} \\ {y}_{20} & {y}_{21} & {y}_{22} & {y}_{23} \\ {y}_{30} & {y}_{31} & {y}_{32} & {y}_{33}\end{matrix} ] [ \begin{matrix}1 & 1 & 1 & 1 \\ 1 & 1 / 2 & - 1 / 2 & - 1 \\ 1 & - 1 & - 1 & 1 \\ 1 / 2 & - 1 & 1 & - 1 / 2\end{matrix} ] ,\end{matrix}$$
wherein Filtered X corresponds to a filtered final data block expressed in a form of a matrix,
C denotes a coefficient matrix,
C^{T} denotes a transpose matrix of C, and
Filtered Y corresponds to a value expressed in a form of a matrix, which is obtained by scaling the IT-ed input data block.

9. A device for-blocking filtering of video data, comprising:
a processor in communication with a memory, the memory including code which when accessed by the processor causes the processor to:
perform an Integer Transform (IT) of an input data block;
scale the IT-ed data blockby applying a modified scaling matrix in which a high frequency area is set to 0; and
perform an Inverse Integer Transform (IIT) on the scaled block.

10. The device of claim 9, wherein, when the input data block is a 4×4 block, the IT is performed by
$$\begin{matrix}{X}^{′} = ( {C}_{f} X {C}_{f}^{T} ) \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ \begin{matrix}{x}_{00} & {x}_{01} & {x}_{02} & {x}_{03} \\ {x}_{10} & {x}_{11} & {x}_{12} & {x}_{13} \\ {x}_{20} & {x}_{21} & {x}_{22} & {x}_{23} \\ {x}_{30} & {x}_{31} & {x}_{32} & {x}_{33}\end{matrix} ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ) ,\end{matrix}$$
wherein X′ denotes an IT-ed block in a form of a matrix,
C denotes a coefficient matrix,
C^{T} denotes a transpose matrix of C,
X denotes an input data block in a form of a matrix.

11. The device of claim 9, wherein application of the modified scaling matrix to the IT-ed block is performed by
Filtered Y=X′ [symbol] S′,
wherein Filtered Y corresponds to a value expressed in a form of a matrix, which is obtained by scaling the IT-ed block,
X′ corresponds to the IT-ed block expressed in a form of a matrix, and
S′ denotes a modified scaling matrix.

12. The device of claim 9, wherein, when the input data block is a 4×4 block, the modified scaling matrix is obtained by
$$\begin{matrix}{S}^{′} = S ⊗ [ \begin{matrix}1 & 1 & 1 & 0 \\ 1 & 1 & 1 & 0 \\ 1 & 1 & 1 & 0 \\ 0 & 0 & 0 & 0\end{matrix} ] , and & \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix} & \end{matrix}$$
wherein S denotes a typical scaling matrix defined by equation (3),
S′ denotes a modified scaling matrix having a radio frequency area set to 0,
a=½, and b=\sqrt{2/5}.

13. The device of claim 9, wherein, when the input data block is a 4×4 block, the modified scaling matrix is obtained by
$$\begin{matrix}S ⊗ [ \begin{matrix}1 & 1 & 1 & 1 \\ 1 & 1 & 1 & 0 \\ 1 & 1 & 1 & 0 \\ 0 & 0 & 0 & 0\end{matrix} ] , and \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}\end{matrix}$$
wherein S denotes a scaling matrix defined by equation (3),
S′ denotes a modified scaling matrix having a radio frequency area set to 0,
a=½, and b=\sqrt{2/5}.

14. The device of claim 9, wherein, when the input data block is a 4×4 block, the modified scaling matrix is obtained by
$$\begin{matrix}S ⊗ [ \begin{matrix}1 & 1 & 1 & 0 \\ 1 & 1 & 1 & 0 \\ 1 & 1 & 1 & 0 \\ 1 & 0 & 0 & 0\end{matrix} ] , and \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}\end{matrix}$$
wherein S denotes a scaling matrix,
S′ denotes a modified scaling matrix having a radio frequency area set to 0,
a=½, and b=\sqrt{2/5}.

15. The device of claim 9, wherein, when the input data block is a 4×4 block, the modified scaling matrix is obtained by
$$\begin{matrix}S ⊗ [ \begin{matrix}1 & 1 & 1 & 0 \\ 1 & 1 & 1 & 0 \\ 1 & 1 & 1 & 1 \\ 0 & 0 & 1 & 1\end{matrix} ] , and \\ \begin{matrix}S = [ \begin{matrix}{a}^{2} & ab / 2 & {a}^{2} & ab / 2 \\ ab / 2 & {b}^{2} / 4 & ab / 2 & {b}^{2} / 4 \\ {a}^{2} & ab / 2 & {a}^{2} & ab / 2 \\ ab / 2 & {b}^{2} / 4 & ab / 2 & {b}^{2} / 4\end{matrix} ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] \\ = [ \begin{matrix}{a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4 \\ {a}^{4} & {a}^{2} {b}^{2} / 2 & {a}^{4} & {a}^{2} {b}^{2} / 2 \\ {a}^{2} {b}^{2} / 2 & {b}^{4} / 4 & {a}^{2} {b}^{2} / 2 & {b}^{4} / 4\end{matrix} ] \\ = [ \begin{matrix}1 / 16 & 1 / 20 & 1 / 16 & 1 / 20 \\ 1 / 20 & 1 / 25 & 1 / 20 & 1 / 25 \\ 1 / 16 & 1 / 20 & 1 / 16 & 1 / 20 \\ 1 / 20 & 1 / 25 & 1 / 20 & 1 / 25\end{matrix} ] ,\end{matrix}\end{matrix}$$
wherein S denotes a typical scaling matrix,
S′ denotes a modified scaling matrix having a radio frequency area set to 0,
a=½, and b=\sqrt{2/5}.

16. The device of claim 9, wherein, when the input data block is a 4×4 block, the IIT is performed by
$$\begin{matrix}Filtered X = {C}_{i}^{T} ( Filtered Y ) {C}_{i} \\ = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] \\ [ \begin{matrix}{y}_{00} & {y}_{01} & {y}_{02} & {y}_{03} \\ {y}_{10} & {y}_{11} & {y}_{12} & {y}_{13} \\ {y}_{20} & {y}_{21} & {y}_{22} & {y}_{23} \\ {y}_{30} & {y}_{31} & {y}_{32} & {y}_{33}\end{matrix} ] [ \begin{matrix}1 & 1 & 1 & 1 \\ 1 & 1 / 2 & - 1 / 2 & - 1 \\ 1 & - 1 & - 1 & 1 \\ 1 / 2 & - 1 & 1 & - 1 / 2\end{matrix} ] ,\end{matrix}$$
wherein Filtered X corresponds to a filtered final data block expressed in a form of a matrix,
C denotes a coefficient matrix,
C^{T} denotes a transpose matrix of C, and
Filtered Y corresponds to a value expressed in a form of a matrix, which is obtained by scaling the IT-ed input data block
